(19) United States
(12) Patent Application Publication
(10) Pub. No.: US 2011/0026250 A1
(43) Pub. Date: Feb. 3, 2011

(54) COLLIMATED SYSTEM WITH MULTI-BACKLIGHT SOURCE

(75) Inventors: Yi-pai Huang, Chiayi City (TW); Ching-yi Hsu, Danshui Town (TW); Yu-cheng Chang, Dajia Town (TW); Chih-ping Su, Keelung City (TW); Chia-lin Liu, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chunghwa Picture Tubes, Ltd., Taoyuan (TW)

(21) Appl. No.: 12/550,527

(22) Filed: Aug. 31, 2009

(30) Foreign Application Priority Data
Jul. 29, 2009 (TW) 098213908

(51) Int. Cl. F21V 5/00; G02B 27/30

(52) U.S. Cl. 362/241; 359/641

(57) ABSTRACT

A multi-backlight collimated system at least comprises a plurality of light sources, a plurality of reflection elements, and at least a collimation element. The light sources are for providing light. Each reflection element has a reflective surface corresponding to one of the light sources and is disposed to reflect light from the corresponding light source. The reflective surface reflects light being emitted in a predetermined direction by the corresponding light source to form a projection area on a screen. The adjacent projection areas on the screen are joined at adjacent side edges. The collimation element is disposed on the screen for altering a path of light penetrating the screen and emitting light in a specific direction The multi-backlight collimated system is easily fabricated into large sizes and is beneficial for products having large display areas.

### TECHNICAL FIELD OF THE INVENTION

The present invention relates to a multi-backlight collimated system, and more particularly, to a multi-backlight collimated system of a planar type.

### BACKGROUND OF THE INVENTION

Nowadays backlight systems are utilized for providing light for image display in most display products such as liquid crystal displays, digital photo frames, e-book readers, mobile phones, stereoscopic displays, displays used in cars, and so on. In addition, backlight systems are also utilized for providing light and projecting static or dynamic images onto screens in projection systems which are widely used for conducting sales demonstrations, business meetings, and classroom instructions. More recently, miniaturization of displays or projection products has become a trend. Consumers require a broad selection of products of different projection areas or display areas. Therefore, the designs and improvements of backlight systems play an important role.

Please refer to FIG. 1, which is a schematic structure diagram illustrating a conventional backlight collimated system 10. The backlight collimated system 10 comprises a light-emitting diode 11 of an edge-lit type, a reflecting plate 12, a concentric guiding panel 14, and a downward concentric collecting layer 16. Light being emitted from the light-emitting diode 11 is directed to the vertical direction, i.e. the Z direction shown in FIG. 1, and is outputted as planar light from the plane on the concentric guiding panel 14. The outputted planar light provides a required amount of light to display images. As shown in FIG. 1, light which is emitted from the light-emitting diode 11 is directed by the reflecting plate 12 and the concentric guiding panel 14 in the backlight collimated system 10. The concentric guiding panel 14 is engraved with reflective surfaces arranged concentrically. These reflective surfaces can direct the propagation of light to a specific direction. The downward concentric collecting layer 16 of the backlight collimated system 10 makes the light from the concentric guiding panel 14 more collimated. Light which is outputted from the downward concentric collecting layer 16 is approximately parallel to the Z direction. The downward concentric collecting layer 16 comprises prisms that have a function of focusing light and are arranged as serration.

However, the concentric guiding panel 14 and the downward concentric collecting layer 16 of the conventional backlight collimated system 10 are expensive because of high manufacturing cost. The process to manufacture the two elements is complicated and is not beneficial for mass production. More importantly, the concentric guiding panel 14 and the downward concentric collecting layer 16 have to be provided with a high precision to conform the optical uniformity standard for displays. However, because the yield rate of the two elements is declined as size is increased, the production of the two elements into large sizes is not preferred. Therefore, the concentric guiding panel 14 and the downward concentric collecting layer 16 are difficult to be applied to produce display panels having large display areas.

Therefore, it is necessary to develop a low-cost multi-backlight collimated system capable of being applied to produce products having large display areas to improve the above-mentioned disadvantages.

### SUMMARY OF THE INVENTION

An objective of the present invention is to provide a multi-backlight collimated system capable of providing light for image display and being applied to flat-panel displays and projection systems.

Another objective of the present invention is to provide a multi-backlight collimated system for solving the problem of being difficult to apply to produce products having large display areas.

Another objective of the present invention is to provide a multi-backlight collimated system for meeting the requirements of miniaturization of display products.

Another objective of the present invention is to provide a multi-backlight collimated system which is suitable for mass production and having an advantage of manufacturing at a low cost.

To achieve the aforesaid objectives, an aspect of the present invention is to provide a multi-backlight collimated system, at least comprising a plurality of light sources, a plurality of reflection elements, and at least a collimation element. The light sources are for providing light. Each reflection element has a reflective surface corresponding to one of the light sources and is disposed to reflect light from the corresponding light source. The reflective surface reflects light being emitted in a predetermined direction by the corresponding light source to form a projection area on a screen. The adjacent projection areas on the screen are joined at adjacent side edges. The collimation element is disposed on the screen for altering a path of light penetrating the screen and emitting light in a specific direction.

Another aspect of the present invention is to provide a multi-backlight collimated system, at least comprising a plurality of light sources, a plurality of reflection elements symmetrically arranged, and at least a Fresnel lens. The light sources are for providing light. Bach reflection element has a reflective surface corresponding to one of the light sources and is disposed to reflect light from the corresponding light source. The reflective surface reflects light being emitted in a predetermined direction by the corresponding light source to form a projection area on a screen. The adjacent projection areas on the screen are joined at adjacent side edges but not overlapping. The Fresnel lens is disposed on the screen for altering a path of light penetrating the screen and emitting light in a specific direction.

Another aspect of the present invention is to provide a multi-backlight collimated system, at least comprising a plurality of light-emitting diodes (LEDs), a plurality of reflection elements symmetrically arranged, and at least a Fresnel lens. The light-emitting diodes are for providing light. Each reflection element has a reflective surface corresponding to one of the light-emitting diodes and is disposed to reflect light from the corresponding light-emitting diode. The reflective surface reflects light being emitted in a predetermined direction by the corresponding light-emitting diode to form a projection area on a screen. The adjacent projection areas on the screen are joined at adjacent side edges but not overlapping. The Fresnel lens is disposed on the screen for altering a path of light penetrating the screen and emitting light in a specific direction.

The multi-backlight collimated system of the present invention has the following advantages. (1) The multi-backlight collimated system of the present invention can be easily fabricated into large sizes and is beneficial for products having large display areas by estimating the position in relation of the light sources and the reflection elements, and the number of their corresponding pairs. (2) The multi-backlight collimated system of the present invention is capable to provide light for image display and meet the requirements of miniaturization of display products particularly for flat-plane displays or projection systems. (3) Light-emitting diodes can be utilized as the light source of the present invention. The multi-backlight collimated system of the present invention has advantages of saving electricity and environmental protection, and conforms to the standards of green technology. (4) The process to manufacture the multi-backlight collimated system of the present invention is simple and is suitable for mass producing at a low cost.

### BRIEF DESCRIPTION OF THE DRAWINGS

FIG. 1 is a schematic structure diagram illustrating a conventional multi-backlight collimated system.

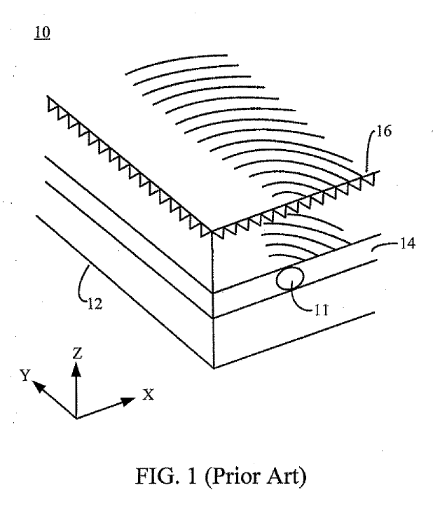

FIG. 2 is a schematic stereogram illustrating a multi-backlight collimated system of the present invention.

FIG. 3 is a sectional diagram of the multi-backlight collimated system of the present invention shown in FIG. 2.

FIG. 4 is a schematic stereogram illustrating a multi-backlight collimated system of the present invention having four projection units.

FIG. 5 is a schematic stereogram illustrating a multi-backlight collimated system of the present invention having six projection units.

FIG. 6 is a schematic stereogram illustrating a multi-backlight collimated system of the present invention utilizing a convex mirror as a reflection element.

FIG. 7 is a structure diagram illustrating a basic Fresnel lens.

### DETAILED DESCRIPTION OF THE INVENTION

The present invention will be described in details in conjunction with the appending drawings.

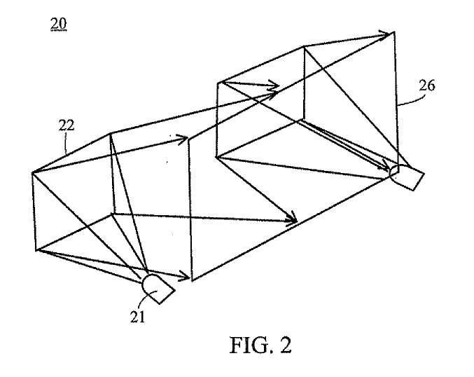

Please refer to FIG. 2, which is a schematic stereogram illustrating a multi-backlight collimated system 20 of the present invention. In the multi-backlight collimated system 20, a projection unit is consisted of a light source 21 and a reflection element 22. There are two projection units shown in FIG. 2. The light source 21 emits light in a predetermined direction. For example, the light source 21 emits light directly toward the reflection element 22. The reflection element 22 reflects light to a collimation element 26. Generally, a function of the collimation element 26 is to change a path of light entered and then outputted with parallel light. In the present invention, light being outputted from the collimation element 26 has a highly directional property and is emitted in a specific direction. The collimation element 26 of the present invention can improve optical density and increase brightness. If the afore-said is applied to flat-panel displays, the multi-backlight collimated system 20 of the present invention is suitable for displays that require only limited viewing directions. However, a scattering sheet can be added behind the collimation element 26 for the multi-backlight collimated system 20 of the present invention if applying to displays that require a broad range of viewing directions.

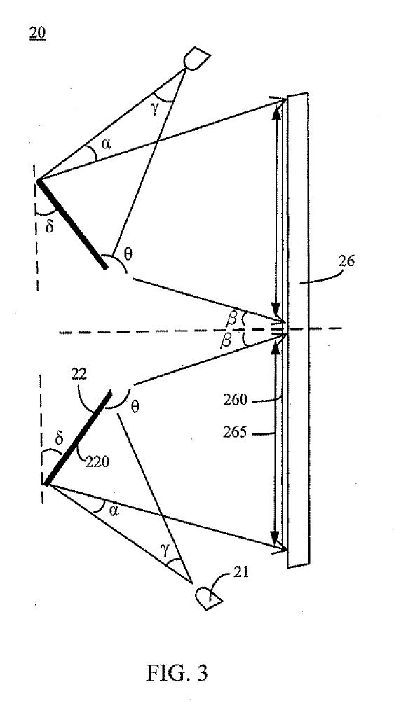

Please refer to FIG. 3, which is a sectional diagram of the multi-backlight collimated system 20 of the present invention shown in FIG. 2. Each reflection element 22 corresponds to a light source 21 and has a reflective surface 220 correspondingly as shown in FIG. 3. Light being emitted in a predetermined direction by the corresponding light source 21 is reflected by the reflective surface 220 of the reflection element 22 and is reflected to a screen 260 to form a projection area 265 on that screen 260. As shown in FIG. 3, each projection unit has its own projection area 265. The adjacent projection areas 265 on the screen 260 are joined together at adjacent side edges but not overlapping extremely. Therefore, there are no bright or dark stripes on the screen 260 and its optical uniformity is great. The collimation element 26 which is disposed on the screen 260 can alter a path of light penetrating that screen 260. The collimation element 26 can transform the entered light into parallel light by focusing or output light in a specific direction. It is noted that the screen 260 of the present invention can be an imaginary plane instead of a real object.

In the present invention, an arrangement relation between the light source 21 and the reflection element 22 of each projection unit, and the collimation element 260 is represented and limited by angles α, β, γ, δ, and θ shown in FIG. 3. The angles α, β, γ, δ, and θ satisfy the following equation:

β+δ+90°=θ

α+2γ=2θ−180°

2δ=α+2β

γ=2β

where α represents an angle between an incident beam corresponding to a first boundary point of the reflective surface 220 and its reflected beam, β represents an angle between a normal line of the screen 260 and a reflected beam reflected from a second boundary point of the reflective surface 220, γ represents an angle between the incident beam corresponding to the first boundary point and another incident beam corresponding to the second boundary point, δ represents an angle between the screen 260 and the reflective surface 220, and θ represents an angle between the reflective surface 220 and the reflected beam reflected from the second boundary point. It is noted that the incident beams and the reflected beams corresponding to the first and second boundary points lie on the same plane.

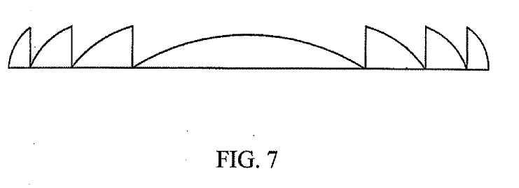

In the present invention, the collimation element 220 of the multi-backlight collimated system 20 may be implemented by Fresnel lens. Fresnel lens is a collecting lens invented by the French physicist Fresnel in 1882. It has been used in many optical systems. Fresnel lens is not merely cheaper but also thinner than ordinary convex lens. It is beneficial to the development of miniaturization of flat-panel displays. Please refer to FIG. 7, which is a structure diagram illustrating a basic Fresnel lens. Fresnel lens and convex lens have a similar function of focusing light. For the same ability of focusing light, Fresnel lens is much thinner than convex lens. Fresnel lens is a non-imaging lens which is suitable for being applied to optical systems that put less emphasis on imaging precision. In general, Fresnel lens is characterized by numerical aperture (NA) which depends on length and focus of optical lens. In order to output with parallel light, the adopted Fresnel lens in the present invention has to satisfy the following equation:

NA=tan β,

where β represents an angle between a normal line of the screen 260 and a light beam reflected from a boundary point of the reflective surface 220. When the numerical aperture of the adopted Fresnel lens does not satisfy the aforementioned equation, the outputted light may be diverged or converged. If attempting to increase a range of viewing direction of display, Fresnel lens may be utilized for its capability of outputting divergent light.

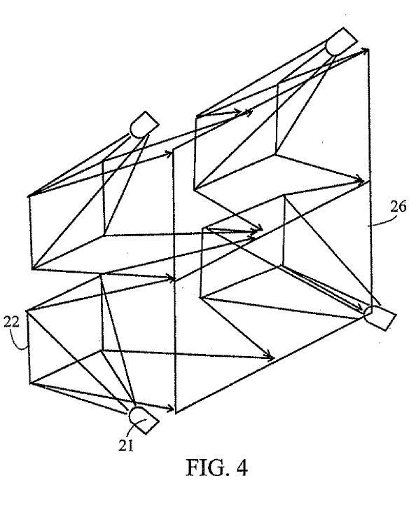

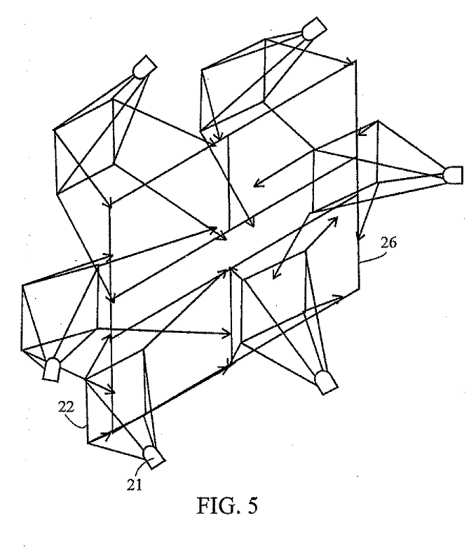

Please refer to FIG. 4 and FIG. 5, which are schematic stereograms illustrating multi-backlight collimated systems 20 of the present invention having four and six projection units, respectively. FIG. 4 shows four projection units and FIG. 5 shows six projection units. Each projection unit is consisted of a light source 21 and a reflection element 22. As respectively shown in FIGS. 2, 4, and 5, all the reflection elements 22 of multi-backlight collimated systems 20 of the present invention are symmetrically arranged. It can be found a symmetrical plane or axis from the positions of all the reflection elements 22. However, an implementation of the reflection elements 22 being arranged asymmetrically for a combination of different numbers of projection units may be possible. It is noted that the number of projection units is not limited in the present invention. The examples of two, four, and six projection units shown in FIGS. 2, 4, and 5, respectively, are for illustration in convenience.

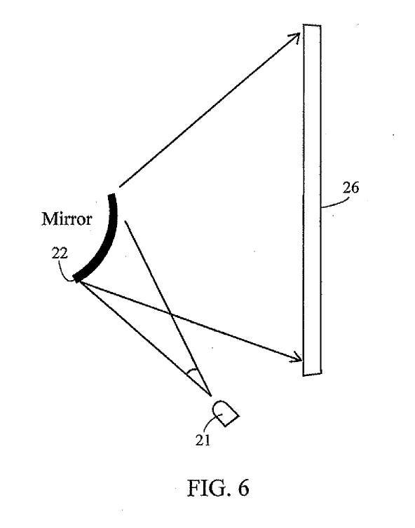

In the present invention, the simplest implementation of reflection element 22 is to use a flat mirror. Because a display panel is usually a rectangular shape, the most direct implementation is to use rectangular flat mirrors to reflect light. The reflected light forms rectangular projection areas which are combined as the display area of the panel. Please refer to FIG. 6, which is a schematic stereogram illustrating a multi-backlight collimated system 20 of the present invention utilizing a convex mirror as the reflection element 22. A convex mirror can be implemented as the reflection element 22 of the multi-backlight collimated system 20 of the present invention instead of a rectangular flat mirror. The advantage of utilizing the convex mirror is that the projection area can be easily extended. In addition, the present invention can utilize light-emitting diodes (LEDs) as the light sources 21 of the multi-backlight collimated system 20. More preferably, light-emitting diodes of high brightness and smaller emitting angle can be utilized.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A multi-backlight collimated system, at least comprising:
a plurality of light sources for providing light;
a plurality of reflection elements, each reflection element having a reflective surface corresponding to one of the light sources and being disposed to reflect light from the corresponding light source, the reflective surface reflecting light emitted in a predetermined direction by the corresponding light source to form a projection area on a screen, the adjacent projection areas on the screen joined at adjacent side edges; and
at least a collimation element, disposed on the screen, for altering a path of light penetrating the screen and emitting light in a specific direction.

2. The multi-backlight collimated system of claim 1, wherein the collimation element is a Fresnel lens of which numerical aperture (NA) satisfies the following equation:
NA=tan β,
where β represents an angle between a normal line of the screen and a light beam reflected from a boundary point of the reflective surface.

3. The multi-backlight collimated system of claim 1, wherein the collimation element is a convex lens.

4. The multi-backlight collimated system of claim 1, wherein the reflection elements are flat mirrors.

5. The multi-backlight collimated system of claim 4, wherein the reflection elements are rectangular flat mirrors.

6. The multi-backlight collimated system of claim 1, wherein the reflection elements are convex mirrors.

7. The multi-backlight collimated system of claim 1, wherein the reflection elements are symmetrically arranged.

8. The multi-backlight collimated system of claim 1, wherein the light sources are light-emitting diodes (LEDs).

9. The multi-backlight collimated system of claim 1, wherein the adjacent projection areas on the screen are joined without overlapping.

10. The multi-backlight collimated system of claim 1, wherein an arrangement relation between the collimation element, each reflection element, and the corresponding light source satisfies the following equation:
β+δ+90°=θ
α+2γ=2θ−180°
2δ=α+2β
γ=2β
where α represents an angle between an incident beam corresponding to a first boundary point of the reflective surface and its reflected beam, β represents an angle between a normal line of the screen and a reflected beam reflected from a second boundary point of the reflective surface, γ represents an angle between the incident beam corresponding to the first boundary point and another incident beam corresponding to the second boundary point, δ represents an angle between the screen and the reflective surface, and θ represents an angle between the reflective surface and the reflected beam reflected from the second boundary point.
